(19) United States
(12) Patent Application Publication
(10) Pub. No.: US 2003/0228812 A1
(43) Pub. Date: Dec. 11, 2003

(54) Flame resistant fabrics comprising filament yarns

(75) Inventors: Michael T. Stanhope, Atlanta, GA (US); Chris Corner, Atlanta, GA (US); Karen A. Kelleher, Mableton, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Southern Mills, Inc., Union City, GA

(21) Appl. No.: 10/165,795

(22) Filed: Jun. 7, 2002

(51) Int. Cl. D03D 19/00; B27N 9/00; D04H 1/00; B32B 5/26; D03D 9/00

(52) U.S. Cl. 442/49; 428/920; 428/921; 442/2; 442/35

(57) ABSTRACT

The present disclosure relates to flame resistant fabrics. In one arrangement, a flame resistant fabric is provided comprising a plurality of flame resistant spun yarns that form a body of the fabric, and a plurality of hybrid strands provided in discrete positions within the fabric body. In one embodiment, the hybrid strands can each include a flame resistant filament yarn and a flame resistant spun yarn that is combined with the filament yarn. In another embodiment, the hybrid strands can each include a flame resistant filament yarn and a plurality of flame resistant fibers that surround the filament yarn. By way of example, the hybrid strands can be arranged in a grid pattern in the flame resistant fabric.

### FIELD OF THE INVENTION

The present invention generally relates to flame resistant fabrics. More particularly, the present invention relates to flame resistant fabrics that comprise filament yarns.

### BACKGROUND OF THE INVENTION

Several occupations require the individual to be exposed to extreme heat and/or flames. To avoid being injured while working in such conditions, these individuals typically wear protective garments constructed of special flame resistant materials designed to protect them from both heat and flame.

To cite an example, firefighters typically wear protective garments commonly referred to in the industry as turnout gear. Such turnout gear normally comprises various garments including, for instance, coveralls, trousers, and jackets. These garments usually include several layers of material including, for example, an outer shell that protects the wearer from flames, a moisture barrier that prevents the ingress of water into the garment, and a thermal barrier that insulates the wearer from the extreme heat.

Turnout gear outer shells typically comprise woven fabrics formed of one or more types of flame resistant fibers. In addition to shielding the wearer from flames, the outer shells of firefighter turnout gear further provides abrasion resistance. In that the outer shell must withstand flame, excessive heat, and abrasion, it must be constructed of a flame resistant material that is both strong and durable. The National Fire Protection Association (NFPA) provides guidelines as to the strength a fabric must have in order to be used in the construction of outer shells. According to NFPA 1971, 2000 edition, the fabric must exhibit a tensile strength of at least 140 pounds (lbs.) in the warp and filling directions, and a trapezoidal tear strength of at least 22 lbs. in the warp and filling directions. The NFPA provides detailed guidelines as to the manner in which testing is to be conducted to determine both tensile strength and tear strength.

As is known in the art, filament yarns can be used to increase the strength of fabrics. For instance, a fabric constructed solely of filament yarns, such as aramid filament yarns, would exhibit very high tear strength and abrasion resistance. Unfortunately, however, filament yarns are relatively slippery. To avoid seam slippage that can occur due to the lubricity of the filament yarns, filament yarns are normally packed tightly together within the fabric, resulting in a relatively stiff fabric. Therefore, forming a garment in which all or substantially all of the yarns of the garment fabric are filament yarns typically yields a fabric so stiff as to render its use in the fabrication protective garments impractical. In an alternative solution, the filament fibers can be back-coated with a substrate material, such as polyurethane. Unfortunately, provision of such back-coatings increases manufacturing costs to the point at which this solution is similarly impractical. In addition, back-coating increases the likelihood of a garment failing the total heat loss (THL) test specified by NFPA 1971.

Further drawbacks to fabrics composed exclusively or nearly exclusively of filament yarns include increased fabric costs due to the higher costs of filament yarns as compared to staple yarns, and difficulty in dyeing of the fabric that results from the crystalline structure of filament yarns that comprise the fabric.

In view of the above-noted drawbacks associated with filament yarns, filament yarns have been blended with spun yarns to increase the strength and abrasion resistance of a fabric. For instance, fabrics have been produced that comprise alternating filament and spun yarns.

Although such blending is a logical solution to the problem of increasing strength without incurring the drawbacks associated with substantially exclusive use of filament yarns, blending filament yarns with spun yarns creates other problems. First, in that filament yarns and spun yarns have different physical characteristics, they can be difficult to process together during fabric manufacture. In addition, these physical differences may also cause fabric puckering due to uneven shrinkage of the filament yarns relative to the spun yarns during laundering. Furthermore, in that filament yarns may be more difficult to dye than spun yarns, particularly where the filament yarns are made of a inherently difficult to dye material such as para-aramid, color uniformity can also be a problem. The uniformity may further be exacerbated by fading that occurs when the exposed filament yarns are constructed of ultraviolet-sensitive materials such as para-aramid. As is known in the art, ultraviolet exposure may further reduce the strength of the filament yarns.

In view of the above, it can be appreciated that it would be desirable to have a fabric that can be used in the construction of protective garments, such as firefighter turnout gear, which incorporates filament yarns but does not suffer from the drawbacks identified above.

### SUMMARY OF THE INVENTION

The present disclosure relates to flame resistant fabrics. In one arrangement, a flame resistant fabric is provided comprising a plurality of flame resistant spun yarns that form a body of the fabric, and a plurality of hybrid strands provided in discrete positions within the fabric body. In one embodiment, the hybrid strands can each include a flame resistant filament yarn and a flame resistant spun yarn that is combined with the filament yarn. In another embodiment, the hybrid strands can each include a flame resistant filament yarn and a plurality of flame resistant fibers that surround the filament yarn. By way of example, the hybrid strands can be arranged in a grd pattern in the flame resistant fabric.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a rear view of an example protective garment.

FIG. 2 is a schematic representation of a fabric that can be used in the construction of the garment of FIG. 1.

FIG. 3 is a schematic representation of a first hybrid strand that can be used to form the fabric of FIG. 2.

FIG. 4 is a schematic representation of a second hybrid strand that can be used to form the fabric of FIG. 2.

FIG. 5 is a schematic representation of a third hybrid strand that can be used to form the fabric of FIG. 2.

FIG. 6 is a schematic representation of a fourth hybrid strand that can be used to form the fabric of FIG. 2.

FIG. 7 is a schematic representation of a fifth hybrid strand that can be used to form the fabric of FIG. 2.

FIG. 8 is a schematic representation of an alternative fabric that can be used in the construction of the garment of FIG. 1.

### DETAILED DESCRIPTION OF THE INVENTION

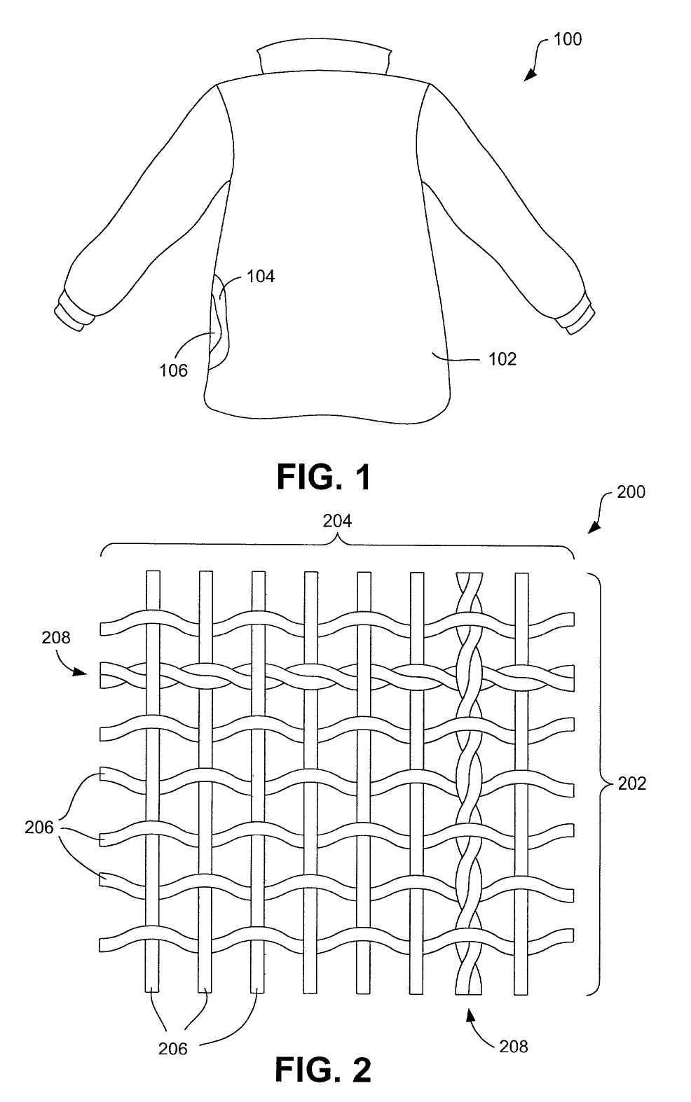

FIG. 1 illustrates an example protective garment 100. More particularly, FIG. 1 illustrates a firefighter turnout coat that can be donned by firefighter personnel when exposed to flames and extreme heat. It is noted that, although a firefighter turnout coat is shown in the figure and described herein, the present disclosure pertains to protective garments generally. Accordingly, the identification of firefighter turnout gear is not intended to limit the scope of the disclosure.

As indicated in FIG. 1, the garment 100 generally comprises an outer shell 102 that forms the exterior surface of the garment, a moisture barrier 104 that forms an intermediate layer of the garment, and a thermal liner 106 that forms the interior surface (i.e., the surface that contacts the wearer) of the garment.

In that it forms the exterior surface of the garment 100, the outer shell 102 preferably is constructed so as to be flame resistant to protect the wearer against being burned. In addition, the outer shell 102 preferably is strong so as to be resistant to tearing and abrasion during use in extreme environments. As identified above, the strength of a fabric, including flame resistant fabrics, can be increased by providing filament yarns in the fabric. Although filament yarns add strength, their use can create various problems that can make their use undesirable.

If filament yarns could be incorporated into a given fabric without the undesirable side-effects associated with their use, stronger flame resistant fabrics could be used to construct protective garments, such as firefighter turnout gear. As is described in detail below, this goal can be achieved by providing in the fabric discretely-positioned hybrid strands of material that comprise a filament component and a spun yarn or fiber component. When such hybrid strands are used in predetermined positions, the strength of the fabric, and therefore the garment, can be significantly improved without sacrificing pliability, processibility, and the like.

FIG. 2 is a schematic view of an example fabric 200 that can be used in the construction of the protective garment 100, and more particularly the outer shell 102, shown in FIG. 1. As indicated in FIG. 2, the fabric 200 can be formed as a plain weave fabric that comprises a plurality of picks 202 and ends 204. Although a plain weave is illustrated and explicitly described, it will be appreciated that other configurations could be used including, for instance, a twill weave configuration, rip-stop, etc.

Generally speaking, the majority of the picks 202 and ends 204 comprise spun yarns 206 that form the body of the fabric 200 and that are constructed of a flame resistant material such as meta-aramid, para-aramid, polynosic rayon, flame resistant cellulosic materials (e.g., flame resistant cotton or acetate), flame resistant wool, flame resistant polyester, polyvinyl alcohol, polytetrafluoroethylene, polyvinyl chloride (PVC), polyetheretherketone, polyetherimide, polyethersulfone, polychlal, polyimide, polyamide, polyimideamide, polyolefin, polybenzoxazole (PBO), polybenzimidazole (PBI), carbon, modacrylic acrylic, melamine, or other suitable flame resistant material. Most preferably, the spun yarns are composed of at least one of meta-aramid, para-aramid, PBI, and PBO. Each spun yarn 206 can comprise a single yarn or two or more individual yarns that are twisted, or otherwise combined, together. Typically, the spun yarns 206 comprise one or more yarns that each have a yarn count in the range of approximately 5 to 60 cc, with 8 to 40 cc being preferred. By way of example, the spun yarns 206 can comprise two yarns that are twisted together, each having a yarn count in the range of approximately 10 to 25 cc.

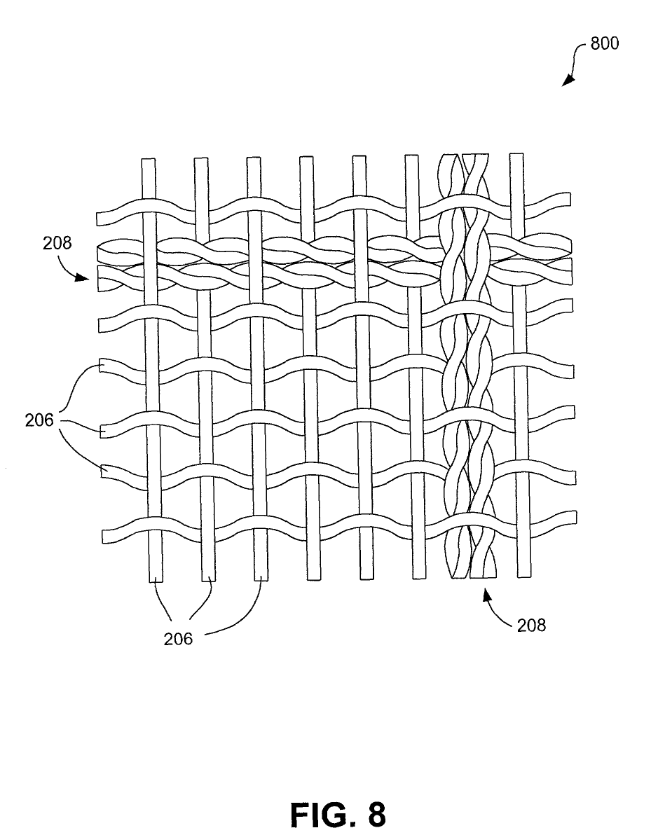

In addition to the spun yarns 206, provided in both the warp and filling directions of the fabric 200 are hybrid strands 208 whose construction is described in greater detail below. Generally speaking, however, the hybrid strands 208 comprise a filament component and a spun yarn or fiber component. As will be appreciated by persons having ordinary skill in the art, the construction of the fabric 200 can be varied depending upon the desired physical properties. The fabric 200 can be constructed such that the hybrid strands 208 are arranged in a grid pattern in which a plurality of spun yarns 206 are placed between each consecutive hybrid strand 208 in both the warp and filling directions of the fabric. As an example, one hybrid strand 208 is provided in the fabric in both the warp and filling directions of the fabric for every approximately seven to nine spun yarns 206. Alternatively, two or more hybrid stands can be woven along with each other in the fabric 200 to form a rip-stop fabric (see FIG. 8). Typically, the grid pattern is arranged so as to form a grid having a plurality of squares. To accomplish this, a greater number of spun yarns 206 may need to be provided between consecutive hybrid strands 208 in the filling direction as compared to the warp direction.

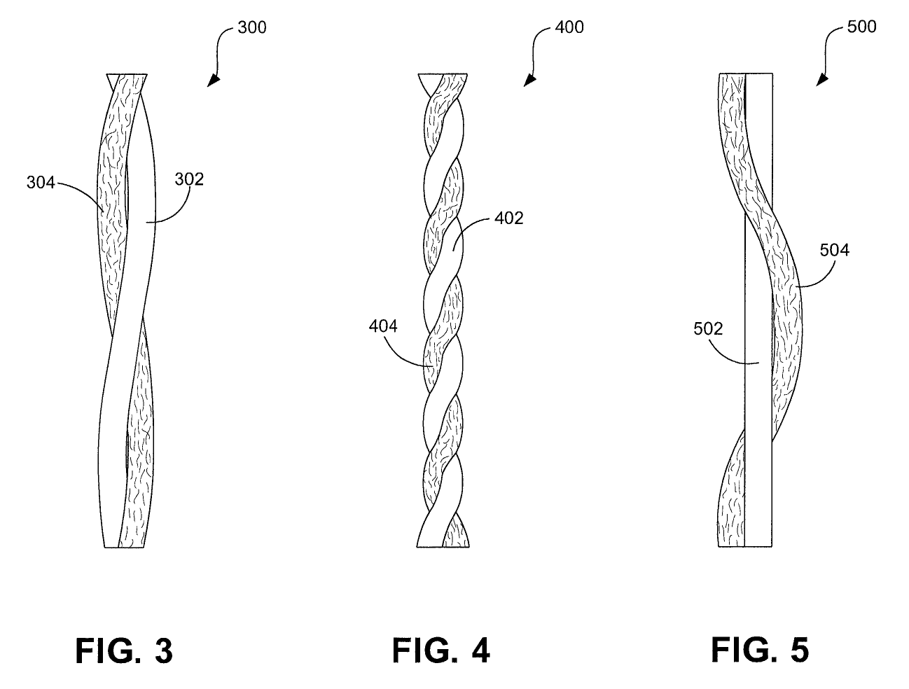

FIGS. 3-7 illustrate various examples of hybrid stands that can be used in the fabric shown in FIG. 2. Beginning with FIG. 3, shown is a hybrid strand 300 that comprises a filament yarn 302 and a spun yarn 304 that are plied together. Although referred to in the singular, the terms “filament yarn” and “spun yarn” are to be understood to include a filament yarn that includes one or more individual continuous filaments and one or more staple fiber spun yarns. Accordingly, the filament yarn 302 can comprise a monofilament yarn or a multifilament yarn, and the spun yarn 304 can include a single spun yarn or a plurality of spun yarns that are twisted together to form a composite yarn. In any case, the filament yarn 302 and the spun yarn 304 can be, shown in FIG. 3, loosely twisted together so as to form an integral strand that can be used as a pick or end as the case may be.

FIG. 4 illustrates a variant of the hybrid strand 300 shown in FIG. 3. In particular, the hybrid strand 400, like strand 300, includes a filament yarn 402 and a spun yarn 404, however, the hybrid strand 400 is formed as a tightly twisted strand such that the filament yarn 402 and spun yarn 404 are more intimately associated along the length of the strand.

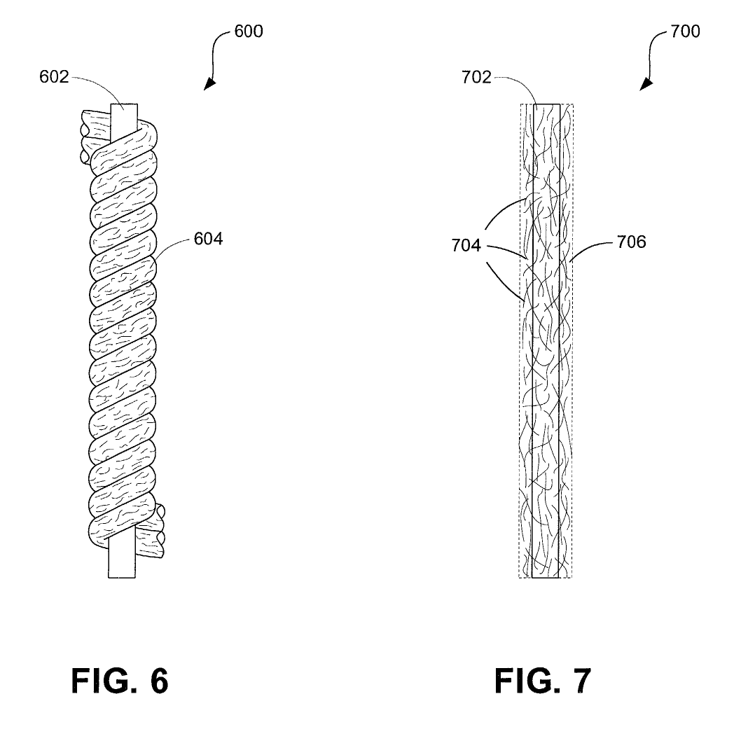

FIG. 5 illustrates a hybrid strand 500 in which the filament yarn 502 is loosely wrapped with a spun yarn 504 to create a core-wrapped arrangement. FIG. 6 illustrates a more tightly core-wrapped arrangement of a hybrid strand 600 that includes a core filament yarn 602 that is substantially completely surrounded by a pair of spun yarns 604. Although two spun yarns 604 are shown wrapped around the filament yarn 602 in FIG. 6, it will be appreciated that fewer or greater spun yarns could be wrapped around the filament yarn in this manner.

In each of the arrangements shown in FIGS. 3-6, various different yarn compositions and weights may be used to obtain advantageous results. With regard to the filament yarn components, each filament yarn can be composed of a flame resistant material such as meta-aramid, para-aramid, flame resistant polyester, polytetrafluoroethylene, polyetheretherketone, polyetherimide, polyethersulfone, polyimide, polyarnide, polyimideamide, polybenzoxazole (PBO), polybenzimidazole (PBI), carbon, glass, or other suitable flame resistant material. Of these, meta-aramid (e.g., Nomex™ ) or para-aramid (e.g., Kevlar™) filament, PBO filament, or glass filament are preferred. The weight of the filament yarns typically is in the range of approximately 60 to 500 denier, with the range of 100 to 500 denier being preferred.

Regarding the spun yarn components, each spun yarn can, like spun yarns 206 identified in FIG. 2, be composed of a flame resistant material such as meta-aramid, para-aramid, polynosic rayon, flame resistant cellulosic materials (e.g., flame resistant cotton or acetate), flame resistant wool, flame resistant polyester, polyvinyl alcohol, polytetrafluoroethylene, polyvinyl chloride (PVC), polyetheretherketone, polyetherimide, polyethersulfone, polychlal, polyimide, polyarnide, polyimideamide, polyolefin, polybenzoxazole (PBO), polybenzimidazole (PBI), carbon, modacrylic acrylic, melamine, or other suitable flame resistant material. Normally, each spun yarn of the given hybrid strand (300, 400, 500, 600) has a yarn count in the range of 5 to 60 cc, with the range 8 to 55 cc being preferred. By way of example, each spun yarn forming the hybrid strands can comprise two yarns that are twisted together, each having a yarn count in the range of approximately 23 to 40 cc.

FIG. 7 illustrates another alternative hybrid strand 700 that includes a core filament yarn 702 about which a plurality of individual staple fibers 704 are spun to form a fiber sheath 706 that surrounds the filament yarn. By way of example, the staple fibers can be spun around the filament yarn 702 using a dref spin procedure. The staple fibers 704 can be constructed of one or more of the various materials identified above for construction of the spun yarn components of the hybrid strands.

FIG. 8 is a schematic view of an example rip-stop fabric 800 that can be used in the construction of the protective garment 100. The fabric 800 is similar to the fabric 200 shown in FIG. 2 and therefore comprises spun yarns 206 that form the body of the fabric and that have composition and construction similar to those described above with regard to FIG. 2. In the fabric 800, however, two hybrid strands 208 are woven along with each other in a grid pattern within the body of the fabric. As noted above, groups of more than two hybrid strands 208 may be used, if desired to form the grid pattern. With the various configurations and compositions described above, the resultant fabric 200 typically has a weight of approximately 3 to 12 ounces per square yard (osy).

With the arrangements disclosed herein, several advantages can be obtained over prior fabrics. First, the tear strength of the fabric is increased due to the discrete provision of the hybrid strands. In that the hybrid strands are provided in discrete positions within the fabric, as opposed to throughout the fabric, excessive stiffness and/or manufacturing cost is avoided. In addition, in that the filament yarns are combined with spun yarns or fibers, manufacturing is simplified. Furthermore, due to the provision of the spun yarns or fibers and the coverage they provide, uneven shrinkage is reduced, greater dye uniformity can be obtained, and less fading occurs, and filament weakening due to ultraviolet exposure is reduced. Optionally, shrinkage can be minimized by autoclaving the fabric and/or its constituents. By way of example, the fabric and/or one or more of its yarns can be autoclaved in a super heated steam atmosphere at approximately 270 F. under pressure for approximately 30 minutes. Through such a procedure, puckering can be more easily avoided.

The following example describes an illustrative fabric that falls within the scope of the disclosure provided above. Included is strength testing data that exhibits the fabric strength that is achieved by the inclusion of the hybrid strands. It is noted that the testing data provided herein was obtained through strict compliance with NFPA 1971.

Example Fabric

A flame resistant fabric blend of Kevlar™ and PBI was constructed having a fabric weight of approximately 6.8 osy. The blend was made as a 2×2 rip-stop fabric having a composition comprising 58 ends per inch and 44 picks per inch, with 9 spun fiber ends provided between every two consecutive hybrid strands in the warp direction and 7 spun fiber picks provided between every two consecutive hybrid strands in the filling direction. Each of the spun yarns forming the body of the blend comprised two 60/40 Kevlar T-970™/PBI yarns having a yarn count of 21 cc (i.e., 21/2). Each hybrid strand comprised a Kevlar™ filament yarn having a weight of 200 denier twisted with a 21/2, 60/40 Kevlar T-970™/PBI spun yarn.

The strength testing results for the fabric are provided in Table 1 for both pre-wash and after wash (i.e., after 5 or 10 launderings in accordance with NFPA 1971.

TABLE I

| | Warp (lbs.) | Filling (lbs.) |
|---|---|---|
| Trapezoidal Tear Strength | | |
| Pre-wash | 69.58 | 68.55 |
| After wash | 44.35 | 30.875 |
| Tensile Strength | | |
| Pre-wash | 337.5 | 258.8 |
| After wash | 240 | 159 |

As can be appreciated from Table I, the example fabric described above provides trapezoidal tear strength that far exceeds the 22 lbs. required by NFPA 1971. Due to the combination of the spun yarns (or fibers as the case may be) with the filament yarns, the disadvantages normally encountered when using filament are avoided. For example, the end fabric can be processed using standard equipment, and will be less susceptible to uneven shrinkage, to non-uniform coloring, and to fading that may occur when exposed filament yarns are used in the fabric's construction.

While particular embodiments of the invention have been disclosed in detail in the foregoing description and drawings for purposes of example, it will be understood by those skilled in the art that variations and modifications thereof can be made without departing from the scope of the invention as set forth in the following claims.

1. A flame resistant fabric, comprising:
a plurality of flame resistant spun yarns that form a body of the fabric; and
a plurality of hybrid strands provided in discrete positions within the fabric body, each hybrid strand including a flame resistant filament yarn and a flame resistant spun yarn that is combined with the filament yarn.

2. The fabric of claim 1, wherein the spun yarns that form the body of the fabric are composed of at least one of meta-aramid, para-aramid, polynosic rayon, flame resistant cellulosic material, flame resistant wool, flame resistant polyester, polyvinyl alcohol, polytetrafluoroethylene, polyvinyl chloride, polyetheretherketone, polyetherimide, polyethersulfone, polychlal, polyimide, polyarnide, polyimideamide, polyolefin, polybenzoxazole, polybenzimidazole, carbon, modacrylic acrylic, and melamine.

3. The fabric of claim 1, wherein the spun yarns that form the body of the fabric are composed of at least one of meta-aramid, para-aramid, polybenzimidazole, and polybenzoxazole.

4. The fabric of claim 1, wherein the hybrid strands are arranged in a grid pattern within the fabric body.

5. The fabric of claim 4, wherein the grid pattern is formed by single hybrid strands.

6. The fabric of claim 4, wherein the grid pattern is formed by groups of two or more hybrid strands that are woven along with each other in the fabric body.

7. The fabric of claim 1, wherein the filament yarns of the hybrid strands are composed of at least one of meta-aramid, para-aramid, flame resistant polyester, polytetrafluoroethylene, polyetheretherketone, polyetherimide, polyethersulfone, polyimide, polyarnide, polyimideamide, polybenzoxazole, polybenzimidazole, carbon, and glass.

8. The fabric of claim 1, wherein the filament yarns of the hybrid strands are composed of at least one of meta-aramid, para-aramid, glass, polybenzoxazole, and carbon.

9. The fabric of claim 1, wherein the filament yarns of the hybrid strands each comprise a filament having a weight in the range of approximately 100 to 500 denier.

10. The fabric of claim 1, wherein the spun yarns of the hybrid strands are composed of at least one of meta-aramid, para-aramid, polynosic rayon, flame resistant cellulosic material, flame resistant wool, flame resistant polyester, polyvinyl alcohol, polytetrafluoroethylene, polyvinyl chloride, polyetheretherketone, polyetherimide, polyethersulfone, polychlal, polyimide, polyarnide, polyimideamide, polyolefin, polybenzoxazole, polybenzimidazole, carbon, modacrylic acrylic, and melamine.

11. The fabric of claim 1, wherein the spun yarns of the hybrid strands are composed of at least one of meta-aramid, para-aramid, and polybenzimidazole.

12. The fabric of claim 1, wherein the spun yarns of the hybrid strands each comprise a spun yarn having a yarn count in the range of approximately 8-40 cotton count.

13. The fabric of claim 1, wherein the spun yarns of the hybrid strands are twisted with the filament yarns to form the hybrid strands.

14. The fabric of claim 1, wherein the spun yarns of the hybrid strands are wrapped around the filament yarns to form the hybrid strands.

15. A flame resistant fabric, comprising:
a plurality of flame resistant spun yarns that form a body of the fabric; and
a plurality of hybrid strands provided in discrete positions within the fabric body, each hybrid strand including a flame resistant filament yarn and a plurality of flame resistant fibers that surround the filament yarn.

16. The fabric of claim 15, wherein the spun yarns that form the body of the fabric are composed of at least one of meta-aramid, para-aramid, polynosic rayon, flame resistant cellulosic material, flame resistant wool, flame resistant polyester, polyvinyl alcohol, polytetrafluoroethylene, polyvinyl chloride, polyetheretherketone, polyetherimide, polyethersulfone, polychlal, polyimide, polyarnide, polyimideamide, polyolefin, polybenzoxazole, polybenzimidazole, carbon, modacrylic acrylic, and melamine.

17. The fabric of claim 15, wherein the spun yarns that form the body of the fabric are composed of at least one of meta-aramid, para-aramid, and polybenzimidazole.

18. The fabric of claim 15, wherein the hybrid strands are arranged in a grid pattern within the fabric body.

19. The fabric of claim 18, wherein the grid pattern is formed by single hybrid strands.

20. The fabric of claim 18, wherein the grid pattern is formed by groups of two or more hybrid strands that are woven along with each other in the fabric body.

21. The fabric of claim 15, wherein the filament yarns of the hybrid strands are composed of at least one of meta-aramid, para-aramid, flame resistant polyester, polytetrafluoroethylene, polyetheretherketone, polyetherimide, polyethersulfone, polyimide, polyarnide, polyimideamide, polybenzoxazole, polybenzimidazole, carbon, and glass.

22. The fabric of claim 15, wherein the filament yarns of the hybrid strands are composed of at least one of meta-aramid, para-aramid, glass, polybenzoxazole, and carbon.

23. The fabric of claim 15, wherein the filament yarns of the hybrid strands each comprise a filament having a weight in the range of approximately 100 to 400 denier.

24. The fabric of claim 15, wherein the flame resistant fibers of the hybrid strands are composed of at least one of meta-aramid, para-aramid, polynosic rayon, flame resistant cellulosic material, flame resistant wool, flame resistant polyester, polyvinyl alcohol, polytetrafluoroethylene, polyvinyl chloride, polyetheretherketone, polyetherimide, polyethersulfone, polychlal, polyimide, polyarnide, polyimideamide, polyolefin, polybenzoxazole, polybenzimidazole, carbon, modacrylic acrylic, and melamine.

25. The fabric of claim 15, wherein the flame resistant fibers of the hybrid strands are composed of at least one of meta-aramid, para-aramid, polybenzimidazole, and polybenzoxazole.

26. The fabric of claim 15, wherein the flame resistant fiber of the hybrid strands are spun around the filament yarns.

27. A protective garment, comprising:
a flame resistant fabric including:
a plurality of flame resistant spun yarns that form a body of the fabric; and
a plurality of hybrid strands provided in discrete positions within the fabric body, each hybrid strand including a flame resistant filament yarn and a flame resistant spun yarn that is combined with the filament yarn.

28. The garment of claim 27, wherein the hybrid strands are arranged in a grid pattern within the fabric body.

29. The garment of claim 28, wherein the grid pattern is formed by single hybrid strands.

30. The garment of claim 28, wherein the grid pattern is formed by groups of two or more hybrid strands that are woven along with each other in the fabric body.

31. The garment of claim 27, wherein the filament yarns of the hybrid strands are composed of at least one of meta-aramid, para-aramid, glass, and polybenzoxazole.

32. The garment of claim 27, wherein the spun yarns of the hybrid strands are composed of at least one of meta-aramid, para-aramid, and polybenzimidazole.

33. The garment of claim 27, wherein the spun yarns of the hybrid strands are twisted with the filament yarns to form the hybrid strands.

34. The garment of claim 27, wherein the spun yarns of the hybrid strands are wrapped around the filament yarns to form the hybrid strands.

35. The garment of claim 27, further comprising a moisture barrier and a thermal liner.

36. A protective garment, comprising:
a flame resistant fabric including:
a plurality of flame resistant spun yarns that form a body of the fabric; and
a plurality of hybrid strands provided in discrete positions within the fabric body, each hybrid strand including a flame resistant filament yarn and a plurality of flame resistant fibers that surround the filament yarn.

37. The garment of claim 36, wherein the hybrid strands are arranged in a grid pattern within the fabric body.

38. The garment of claim 37, wherein the grid pattern is formed by single hybrid strands.

39. The garment of claim 37, wherein the grid pattern is formed by groups of two or more hybrid strands that are woven along with each other in the fabric body.

40. The garment of claim 36, wherein the filament yarns of the hybrid strands are composed of at least one of meta-aramid, para-aramid, glass, polybenzoxazole, and carbon.

41. The garment of claim 36, wherein the flame resistant fibers of the hybrid strands are composed of at least one of meta-aramid, para-aramid, polybenzimidazole, and polybenzoxazole.

42. The garment of claim 36, wherein the flame resistant fiber of the hybrid strands are spun around the filament yarns.

43. A method for forming a flame resistant fabric, comprising:
arranging a plurality of flame resistant spun yarns to form a body of the fabric; and
forming a grid of hybrid strands in the fabric body, each hybrid strand including a flame resistant filament yarn and a flame resistant spun yarn that is combined with the filament yarn.

44. A method for forming a flame resistant fabric, comprising:
arranging a plurality of flame resistant spun yarns to form a body of the fabric; and
forming a grid of hybrid strands in the fabric body, each hybrid strand including a flame resistant filament yarn and a plurality of flame resistant fibers that surround the filament yarn.
